(19) United States
(12) Patent Application Publication
(10) Pub. No.: US 2009/0024839 A1
(43) Pub. Date: Jan. 22, 2009

(54) Variable instruction set microprocessor

(76) Inventor: Paul (Plamen) Arssov, San Diego, CA (US)

Correspondence Address: PAUL ARSSOV, 7930 AVENIDA NAVIDAD #116, SAN DIEGO, CA, 92122, US

(21) Appl. No.: 11/781,245

(22) Filed: Jul. 21, 2007

(51) Int. Cl. G06F 9/30

(52) U.S. Cl. 712/226; 712/E09.032

(57) ABSTRACT

A new Variable instruction set microprocessor consisting of a fixed instruction set part, together with a programmable logic part, where custom instructions can be dynamically added at any time of the work of the said.

The Variable instruction set microprocessor, has several fixed instructions in the fixed instruction set part, specifically for adding, modifying, deleting, executing custom instructions.

One computing task of the said microprocessor can be achieved by a single, or a limited number of custom instructions, instead of a long total number of general fixed instructions.

The data operands of the said microprocessor can be with a variable length, independent of, and smaller or larger than the 8/16/32/64/128 bit data bus length of the general fixed instructions microprocessor. The speed of executing of the custom commands of the said can be the maximum internal speed of the microprocessor.

### BACKGROUND OF THE INVENTION

1. Field of Invention

The invention herein relates to microprocessors and programmable logic.

2. Description of Related Art

Currently microprocessors are the central part in the majority of electronic and computer devices.

The current microprocessors have fixed instructions in both—the manufactured in silicon microprocessors, and the microprocessors used as an intellectual property and loaded in programmable logic.

Some examples of microprocessor instructions are:
move data from one to another location,
shift data left or right,
add, subtract, multiply, divide data.

A program using the fixed instruction set of a microprocessor, can achieve unlimited tasks—as a software driver commanding a hardware device, as a software application providing functionality, information, interaction for a user, or any other type.

However the length of data used in a instruction is fixed to dealing with—8, 16, 32, 64, 128, etc. bits at a time.

In addition, to achieve a specific task while using the general instructions of a microprocessor, requires executing many general instructions, and slows down achieving the desired end result.

One possible solution in order to speed up the execution of tasks is to use not one but a number of general fixed instruction set microprocessors, so that the computing tasks are divided between the different processors. However the job of dividing tasks between all of the microprocessors is quite complex, while the results are still achieved by using the fixed instruction set.

Another possible solution is to use specific hardware accelerators which have programmable logic, and are attached to the general bus of the computing system, outside of the microprocessor. However the programmable logic normally works on a much lower speed (frequency) compared to the internal speed of the microprocessor.

### SUMMARY OF THE INVENTION

The invention—Variable instruction set microprocessor, allows adding custom instructions to the general fixed instruction set of a microprocessor.

The invention is expressed in:
adding a programmable logic within a microprocessor, which can be customized to express specific custom instructions, and
adding a number of specific instruction to the general fixed set of instructions of the microprocessor specifically for—adding, modifying, deleting, executing of a custom instruction.

One instruction is defined with 2 basic fields:
Command (or code) of the instruction—which defines what the instruction is going to perform, like for ex. read from memory, multiply 2 operands, etc.
Data (operand(s)) of the instruction—which can be one or more registers of the microprocessor, pointers to memory area, etc.

One custom instruction needs to be defined and added first in the programmable memory area in the microprocessor—using ‘CUSTOM ADD’ instruction.

One custom instruction, which have been previously added to the general fixed instruction set of a microprocessor, can be executed in a number of ways, while within the general flow of instructions of a program which the microprocessor runs:
running directly the new instruction code and data, or
running several specific commands including using of:

‘CUSTOM LOAD INPUT DATA’ instruction—may not be needed to be executed if previously loaded data is used,

‘CUSTOM EXECUTE CODE’ instruction,

‘CUSTOM GET OUTPUT DATA’ instruction—may not be needed to be executed if there are no results after executing.

One custom instruction, which have been previously added, can be modified—using ‘CUSTOM MODIFY’ instruction, or deleted—using ‘CUSTOM DELETE’ instruction for deleting from the programmable memory area in the microprocessor.

The said custom instructions serve as an example of implementation, which can also be achieved in a variety of different ways.

Variable instruction set microprocessor allows custom instructions to be dynamically added at any time of the work of the Variable instruction set microprocessor.

In this way one computing task will be achieved by a single, or a limited number of custom instructions, instead of a long total number of general fixed instructions.

The data operands will be with a variable length, independent of, and even much larger, than the data bus length of the general fixed instructions microprocessor.

The speed of executing of the custom command will be the maximum internal speed of the microprocessor.

The best implementation of Variable instruction set microprocessor is within the high performance microprocessors, like for example the ones manufactured by—Intel and AMD (x86 based), IBM (Power PC based), Sun Microsystems, as well as other high performance microprocessors.

### BRIEF DESCRIPTION OF THE DRAWINGS

FIG. 1. is a diagram showing the existing standard microprocessor.

FIG. 2. is a diagram showing a Variable instruction set microprocessor.

FIG. 3. is a diagram showing a sample sequence of instructions executed by a Variable instruction set microprocessor.

### DETAILED DESCRIPTION OF THE INVENTION

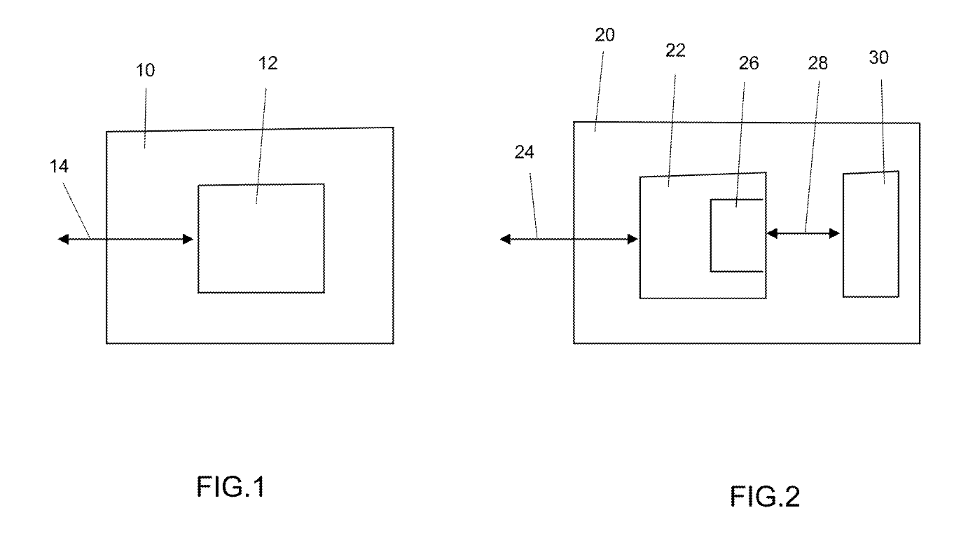

FIG. 1. shows the implementation of the existing standard microprocessor, where the standard microprocessor 10, has a fixed instruction set 12, and communicates through an external processor bus 14.

FIG. 2. shows the implementation of the Variable instruction set microprocessor, where the Variable instruction set microprocessor 20, has a fixed instruction set part 22, and communicates through an external processor bus 24. Inside of the fixed instruction set part 22, there are the additional commands 26 to the fixed set of instructions 22, which communicate with the programmable logic 30 through an internal processor bus 28.

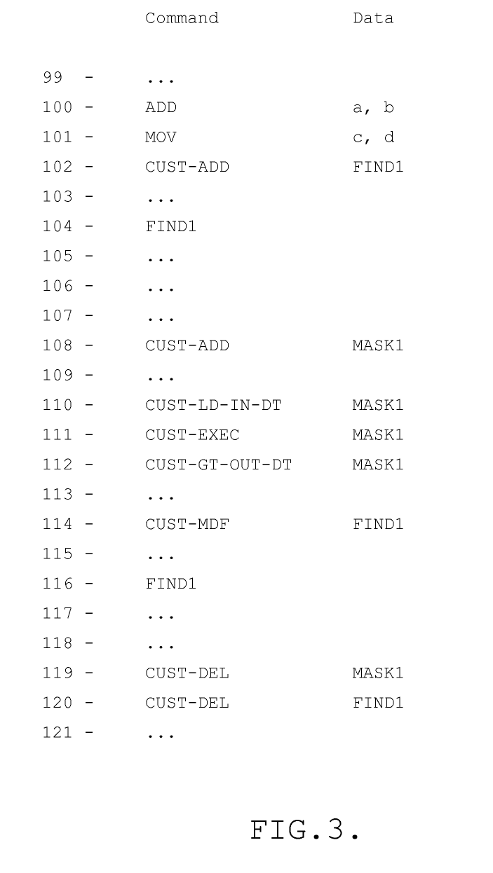

FIG. 3. shows a sample sequence of instructions executed by a Variable instruction set microprocessor—one after another, from the instruction 99 to instruction 121 and further on. The sequence has a Command portion, and a Data potion.

Instructions 99, 100, 101, 103, 105, 106, 107, 109, 113, 115, 117, 118, 121 on FIG. 3. are general processor instruction belonging in the fixed instruction set of processor shown as 22 on FIG. 2. Examples of such instructions are instruction 100—‘ADD a, b’, and instruction 101—‘MOV c, d’ on FIG. 3.

Instruction 102 on FIG. 3. shows adding a custom instruction named as ‘FIND1’. The instruction for adding ‘CUST-ADD’ belongs to the the fixed instruction set of processor shown as 22 on FIG. 2 and appears in the Command potion of the instruction. The new instruction named as ‘FIND1’, appears in the Data portion of the instruction. The said is loaded in the the programmable logic shown as 30 on FIG. 2.

The content, loaded in the programmable logic shown as 30 on FIG. 2. to define a custom instruction, like for example—‘FIND1’ in 102 of FIG. 3., can be taken from the internal registers or memory located within the microprocessor, or from the external memory located outside of the microprocessor.

Instruction 104 on FIG. 3. shows direct execution of the previously defined instruction named ‘FIND1’. The said appears in the Command potion of the instruction 104. The Data portion of the new instruction named as ‘FIND1’ can be taken from internal registers or memory located within the microprocessor, or from external memory located outside of the microprocessor.

Instruction 108 on FIG. 3. shows adding a custom instruction named as ‘MASK1’. The new instruction named as ‘MASK1’ is added in the same way as in instruction 102.

Instruction 110 on FIG. 3. shows loading of input data for a custom instruction named as ‘MASK1’. The instruction for loading ‘CUST-LD-IN-DT’ belongs to the the fixed instruction set of processor shown as 22 on FIG. 2 and appears in the Command potion of the instruction. The Data portion of the instruction states that the input data is specific to a custom instruction named ‘MASK1’. The input data can be taken from the internal registers or memory located within the microprocessor, or from the external memory located outside of the microprocessor.

Instruction 111 on FIG. 3. shows executing of a custom instruction named as ‘MASK1’. The instruction for executing ‘CUST-EXEC’ belongs to the the fixed instruction set of processor shown as 22 on FIG. 2 and appears in the Command potion of the instruction. The Data portion of the instruction states that the custom instruction named ‘MASK1’ will be executed.

The instruction 111 has similar functionality of executing a custom instruction as instruction 104, performed in a different way.

Instruction 112 on FIG. 3. shows getting of the output data of a custom instruction named as ‘MASK1’. The instruction for getting ‘CUST-GT-OUT-DT’ belongs to the the fixed instruction set of processor shown as 22 on FIG. 2 and appears in the Command potion of the instruction. The Data portion of the instruction states that the output data after execution of custom instruction named ‘MASK1’ will be gotten. The output data can be stored in the internal registers or memory located within the microprocessor, or from the external memory located outside of the microprocessor.

Instruction 114 on FIG. 3. shows modifying of a previously added custom instruction named as ‘FIND1’. The instruction for modifying ‘CUST-MDF’ belongs to the the fixed instruction set of processor shown as 22 on FIG. 2 and appears in the Command potion of the instruction.

The Data portion of the instruction states that the instruction named as ‘FIND1’ will be modified. The said is loaded in the the programmable logic shown as 30 on FIG. 2.

The content loaded in the programmable logic shown as 30 on FIG. 2. to modify a custom instruction ‘FIND1’, can be taken from internal registers or memory located within the microprocessor, or from the external memory located outside of the microprocessor.

Instruction 116 on FIG. 3. shows direct execution of the previously modified instruction named ‘FIND1’. The said appears in the Command potion of the instruction 104. The Data portion of the new instruction named as ‘FIND1’ can be taken from internal registers or memory located within the microprocessor, or from external memory located outside of the microprocessor.

Instruction 119 on FIG. 3. shows deleting of a custom instruction named as ‘MASK1’. The instruction for deleting ‘CUST-DEL’ belongs to the the fixed instruction set of processor shown as 22 on FIG. 2 and appears in the Command potion of the instruction. The instruction named as ‘MASK1’, appears in the Data portion of the instruction. The said is deleted from the programmable logic shown as 30 on FIG. 2.

Instruction 120 on FIG. 3. shows deleting of a custom instruction named as ‘FIND1’. The instruction for deleting ‘CUST-DEL’ belongs to the the fixed instruction set of processor shown as 22 on FIG. 2 and appears in the Command potion of the instruction. The instruction named as ‘FIND1’, appears in the Data portion of the instruction. The said is deleted from the programmable logic shown as 30 on FIG. 2.

The invention can be reduced into practice in many different ways, including:
using one of the manufactured in high volumes existing high performance processors, adding commands as described, adding programmable logic, and fabricating the resulting chip, or
using one of the available as intellectual property microprocessors, adding commands as described to the intellectual property, and loading the resulting intellectual property in a general programmable logic chip, like for ex. in a FPGA.

The implementing of the Variable instruction set microprocessor in the way of a hardware and a software will be well known for those with ordinary skills in hardware and software design.

The description of the embodiments of this invention has been presented for purposes of illustration. The embodiments were chosen and described to provide the best illustration of the principles of this invention and its practical application.

Those skilled in the art are enabled by the said illustration to utilize the invention in various embodiments and with various modifications as are suited to the particular use contemplated.

All such modifications and variations are within the scope of the present invention as determined by the appended claims.

1. A Variable instruction set microprocessor consisting of:
a fixed instruction set part, and
a programmable logic part.

2. A Variable instruction set microprocessor from claim 1, where the fixed instruction set part has fixed instructions, specifically for:
adding a custom instruction in the programmable logic part,
modifying of previously added custom instruction in the programmable logic part,
deleting of previously added custom instruction in the programmable logic part.

3. A Variable instruction set microprocessor from claim 1, where the custom instruction which have been added in the programmable logic part can be executed within the general flow of instructions of the microprocessor, by directly executing the new instruction Command.

4. A Variable instruction set microprocessor from claim 1, where the custom instruction which have been added in the programmable logic part can be executed within the general flow of instructions of the microprocessor, by executing several commands within the fixed instruction set part including:
loading of input data for a custom instruction,
executing of a custom instruction,
getting of output data of a custom instruction.

5. A Variable instruction set microprocessor from claim 1, where one or more custom instructions can be dynamically added in the programmable logic part, at any time of the work of the Variable instruction set microprocessor.

6. A Variable instruction set microprocessor from claim 1, where a complex computing task can be achieved by a single, or a limited number of custom instructions, instead of a long total number of general fixed instructions.

7. A Variable instruction set microprocessor from claim 1, where the data operands of a custom instruction can have a variable length, independent of, and smaller or larger than the 8/16/32/64/128 bit data bus length of the general fixed instructions microprocessor.

8. A Variable instruction set microprocessor from claim 1, where the speed of executing of a custom instruction can be the maximum internal speed of the microprocessor.
